(19) United States
(12) Patent Application Publication
(10) Pub. No.: US 2007/0018842 A1
(43) Pub. Date: Jan. 25, 2007

(54) Illuminated crystal display panel

(75) Inventor: Jackson Luk Wah Chu, Hong Kong (HK)

Correspondence Address: LEYDIG VOIT & MAYER, LTD, 700 THIRTEENTH ST. NW, SUITE 300, WASHINGTON, DC, 20005-3960, US

(73) Assignee: Ewig Industries Macao Commercial Offshore Limited, Macau (CN)

(21) Appl. No.: 11/184,800

(22) Filed: Jul. 20, 2005

(51) Int. Cl. G09F 9/33

(52) U.S. Cl. 340/815.45

(57) ABSTRACT

A display device includes a light-transmissive block, typically made of plastics or glass material and has a number of light-reflective features located internally thereof. A number of LEDs illuminate the light-reflective features.

### BACKGROUND OF THE INVENTION

The present invention relates to display panels. More particularly, although not exclusively, the invention relates to a display panel for use in devices such as desktop weather stations, clock radios, television sets and the like.

Display panels using liquid-crystal technology are well known. Indeed liquid crystal displays (LCDS) are used in many devices including desktop weather stations, calculators, personal music players and the like.

### OBJECTS OF THE INVENTION

The present invention aims at providing an aesthetically pleasing alternative to standard liquid-crystal display panels used in such and other devices.

### DISCLOSURE OF THE INVENTION

There is disclosed herein a display device, comprising:

a light-transmissive block having a light-reflective feature located internally thereof, and

a light source illuminating the light-reflective feature.

Preferably, the device comprises a plurality of said light-reflective features located nearby one another within the block.

Preferably, the device comprises a plurality of said light sources individually illuminating respective ones of said light-reflective features.

Preferably, each or some of said light sources emit light of different wavelength.

Preferably, said light sources are LEDs.

Preferably, said block is made of plastics, crystal or glass material.

Preferably, said light-reflective feature is laser-etched into the block.

Preferably, said light-reflective feature is three-dimensional.

There is further disclosed herein a desktop weather station incorporating the above-disclosed device, wherein the LEDs are controlled by circuitry to illuminate one of the light-reflective features, and wherein each of the light-reflective features is in the shape of a weather-related icon.

### BRIEF DESCRIPTION OF THE DRAWINGS

A preferred form of the present invention will now be described by way of example with reference to the accompanying drawings, wherein;

FIG. 1 is schematic front elevation of a desktop weather station,

FIG. 2 is a schematic plan view of the desktop weather station of FIG. 1,

FIG. 3 is a schematic left side elevation of the desktop weather station of FIG. 1,

FIG. 4 is a schematic right side elevation of the desktop weather station.

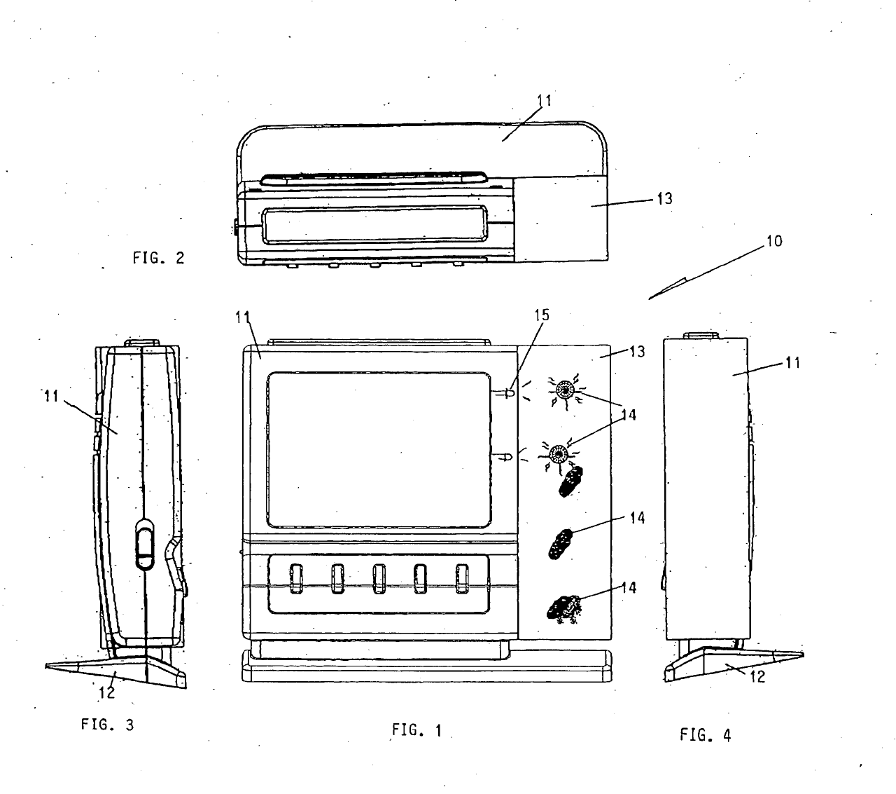

### DESCRIPTION OF THE PREFERRED EMBODIMENT

In the accompanying drawings there is depicted schematically a desktop weather station 10 comprising a main body 11 upon a base 12. Attached to the main body 11 is a display device 13 typically in the form of a clear acrylic block having a number of laser-etched two- or preferably three-dimensional icons 14 therein. One or more LEDs 15 are provided within the main body 11 and each being directed toward a respective one of the icons 14. The icons 14 might take on the appearance of clouds, the sun, rain, or might comprise words, letters, numbers or other symbols.

Circuitry within the weather station might receive information from a built-in thermometer, hygrometer or other device and selectively illuminate one of the LEDs 15.

It should be appreciated that modifications and alterations obvious to those skilled in the art are not to be considered as beyond the scope of the present invention. For example, the block might be made of glass or crystal or other material suitable for the formation therein by laser technology of three-dimensional features. Also, where two-conventional icons are employed, they might be laminated between a pair of light-transmissive blocks, rather than being laser-etched in a single block. Furthermore, the invention is not limited to desktop weather stations, and might be employed in clock radios, or other devices currently employing LCD panels for example.

1. A display device, comprising:
a light-transmissive block having a light-reflective feature located internally thereof, and
a light source illuminating the light-reflective feature.

2. The device of claim 1, comprising a plurality of said light-reflective features located nearby one another within the block.

3. The device of claim 2, comprising a plurality of said light sources individually illuminating respective ones of said light-reflective features.

4. The device of claim 3, wherein each or some of said light sources emit light of different wavelength.

5. The device of claim 3, wherein said light sources are LEDs.

6. The device of a claim 1, wherein said block is made of plastics, crystal or glass material.

7. The device of claim 6, wherein said light-reflective feature is laser-etched into the block.

8. The device of claim 1, wherein said light-reflective feature is three-dimensional.

9. A desktop weather station incorporating the device of claim 3, wherein the LEDs are controlled by circuitry to illuminate one of the light-reflective features, and wherein each of the light-reflective features is in the shape of a weather-related icon.
